(19) United States
(12) Patent Application Publication
(10) Pub. No.: US 2024/0126218 A1
(43) Pub. Date: Apr. 18, 2024

(54) PERSONAL DIGITAL MODULE

(71) Applicant: WILCOX INDUSTRIES CORP., Newington, NH (US)

(72) Inventors: James W. Teetzel, Portsmouth, NH (US); Gary M. Lemire, Lee, NH (US); Mathew A. Reichl, Portsmouth, NH (US)

(21) Appl. No.: 18/380,537

(22) Filed: Oct. 16, 2023

Related U.S. Application Data
(60) Provisional application No. 63/416,846, filed on Oct. 17, 2022.

(51) Int. Cl. G04G 21/02; G04G 17/08; G04G 21/04; G04G 21/08; G06F 21/32

(52) U.S. Cl. CPC G04G 21/025; G04G 17/08; G04G 21/04; G04G 21/08; G06F 21/32

(57) ABSTRACT

A personal digital module comprises a housing and a processor with an associated computer-readable memory disposed within the housing. The memory is operably coupled to the processor and encoded with executable instructions. A human-viewable display operably is coupled to the processor and disposed within the housing. A connection interface is disposed on the housing and is configured for detachable and interchangeable attachment of first device and a second device. The processor is configured, upon execution of the executable instructions, to perform a first function associated with the first device when the personal digital module is attached to the first device and to perform a second function associated with the second device when the personal digital module is attached to the second device.

### CROSS REFERENCE TO RELATED APPLICATION

This application claims the priority benefit of U.S. provisional application No. 63/416,846 filed Oct. 17, 2022. The aforementioned application is incorporated herein by reference in its entirety.

### BACKGROUND

The present invention relates to a personal digital module comprising a computer-based information handling system that has customizable screens configurable by the user through a wireless interface, such as a Bluetooth application, via a mobile device, such as a cell phone, or via a laptop or desktop computer. The personal digital module can be decoupled from a watch base module and moved from device to device utilizing a common, locking, plug/socket combination and any device-specific, pre-programmed preferences are automatically applied when paired.

The personal digital module can be used as a controlling device or as a simple display. Each device as well as the personal digital module itself can be configured to only allow access through facial recognition and/or biometric measurements from the watch base sensors.

### SUMMARY

In one aspect, a personal digital module comprises a housing and a processor with an associated computer-readable memory disposed within the housing. The memory is operably coupled to the processor and encoded with executable instructions. A human-viewable display operably is coupled to the processor and disposed within the housing. A connection interface is disposed on the housing and is configured for detachable and interchangeable attachment of first device and a second device. The processor is configured, upon execution of the executable instructions, to perform a first function associated with the first device when the personal digital module is attached to the first device and to perform a second function associated with the second device when the personal digital module is attached to the second device.

In a more limited aspect, the processor is configured, upon execution of the executable instructions, to receive a first set of user preferences from the first device when the personal digital module is attached to the first device and to receive a second set of user preferences from the second device when the personal digital module is attached to the second device.

In another more limited aspect, the human-viewable display further comprises a touch screen.

In another more limited aspect, the first device is a watch base module wearable on a wrist of a user.

In another more limited aspect, the watch base module comprises one or more biometric sensors for collecting biometric data from the user and the executable instructions comprise an authentication module configured to biometrically authenticate the user.

In another more limited aspect, the personal digital module further comprises a wireless communications interface between the personal digital module and the watch base module configured to transmit data from the one or more biometric sensors to the personal digital module.

In another more limited aspect, the personal digital module is configured to monitor for presence of the user at periodic intervals during operation of the first or second device.

In another more limited aspect, the personal digital module is configured to biometrically authenticate the user at periodic intervals during operation of the first or second device.

In another more limited aspect, the one or more biometric sensors are selected from the group consisting of a camera, an ECG sensor, and an EDA sensor.

In another more limited aspect, the watch base module includes an annular receptacle configured to detachably receive the connection interface, the annular receptacle having one or more pivoting lock bars engaging complementary slots on the connection interface.

In another more limited aspect, the one or more lock bars are manually actuatable for detaching the personal digital module from the watch base module.

In another more limited aspect, the second device is selected from the group consisting of a fire control system, a parachutist navigation system, and a helmet mounting system.

In another more limited aspect, the second device is a fire control system and the personal digital module is configured to display one or more indicia associated with the fire control system, wherein the one or more indicia are selected from the group consisting of battery power indicia, range to target indicia, laser status indicia, reticle indicia, zoom magnification indicia, and any combination thereof.

In another more limited aspect, the second device is a parachutist navigation system comprising a digital compass, an altimeter, and a global satellite positioning receiver, and the personal digital module is configured to selectively provide a graphical user interface representative of orientation based on data received from the digital compass, altitude based on data received from the altimeter, and location based on data received from the global satellite positioning receiver.

In another more limited aspect, the second device is a helmet mounting system.

In another more limited aspect, the personal digital module is operable to control a function of a helmet-mounted device attached to the helmet mounting system.

In another more limited aspect, the helmet mounting system includes an IFF beacon, and wherein the personal digital module is operable to control operation of the IFF beacon.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of the personal digital module attached to the watch base module.

FIG. 2 is an isometric view of the personal digital module and the watch base module separated to expose the common receiver socket.

FIG. 3 is an enlarged isometric view of the personal digital module.

FIG. 4 is an exploded isometric view of the personal digital module.

FIG. 5 is an isometric view of the watch base module.

FIG. 6 is an exploded isometric view of the watch base module showing the spring-loaded locking mechanism, biometric module, and audio/visual flex PCB.

FIG. 7 is a view showing the common interface between modules.

FIG. 8 illustrates the personal digital module interfacing with a first exemplary device (i.e., fire control system).

FIG. 9 illustrates the personal digital module interfacing with a second exemplary device (i.e., parachutist navigation system).

FIG. 10 is an enlarged view of the region 10 appearing in FIG. 9.

FIG. 11 illustrates the personal digital module interfacing with a third exemplary device (i.e., helmet mounting system).

FIG. 12 is an enlarged view of the region 12 appearing in FIG. 11.

FIG. 13 is a block diagram depicting the personal digital module interfacing with a watch base module, fire control system, parachutist navigation system, and a helmet mounting system.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

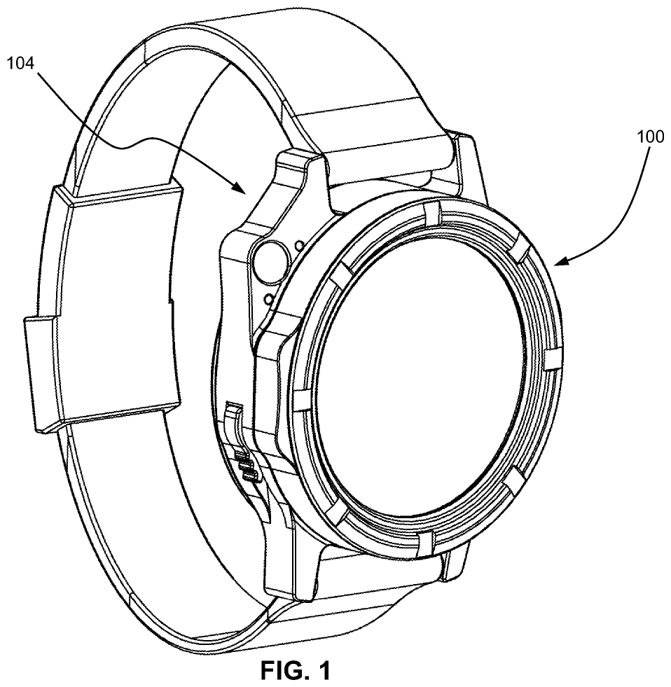

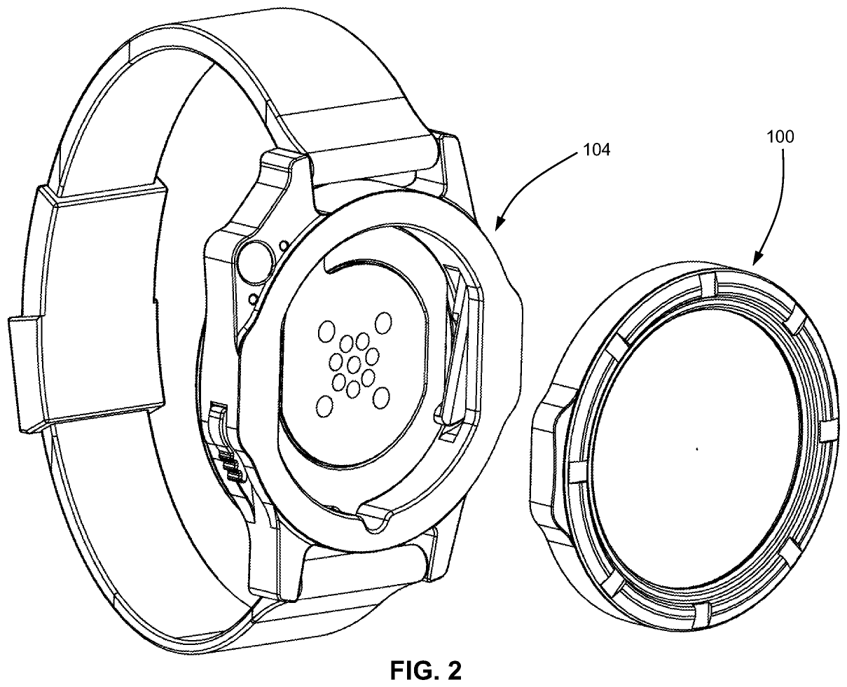

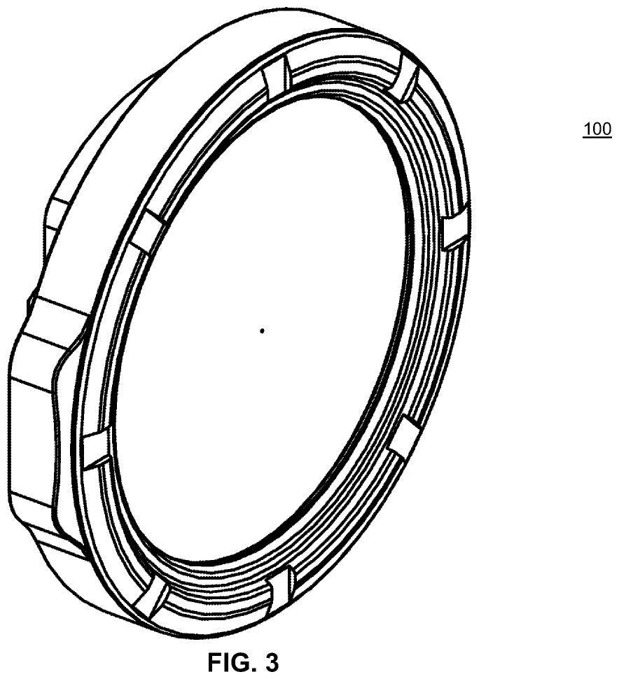

Referring to FIG. 1, there appears a personal digital module 100 attached to a base module 104, which is similar in form factor to a traditional wrist watch and will be referred to herein as a watch base module. FIG. 2 illustrates the personal digital module removed from the watch base module 104. An enlarged view of the personal digital module 100 appears in FIG. 3.

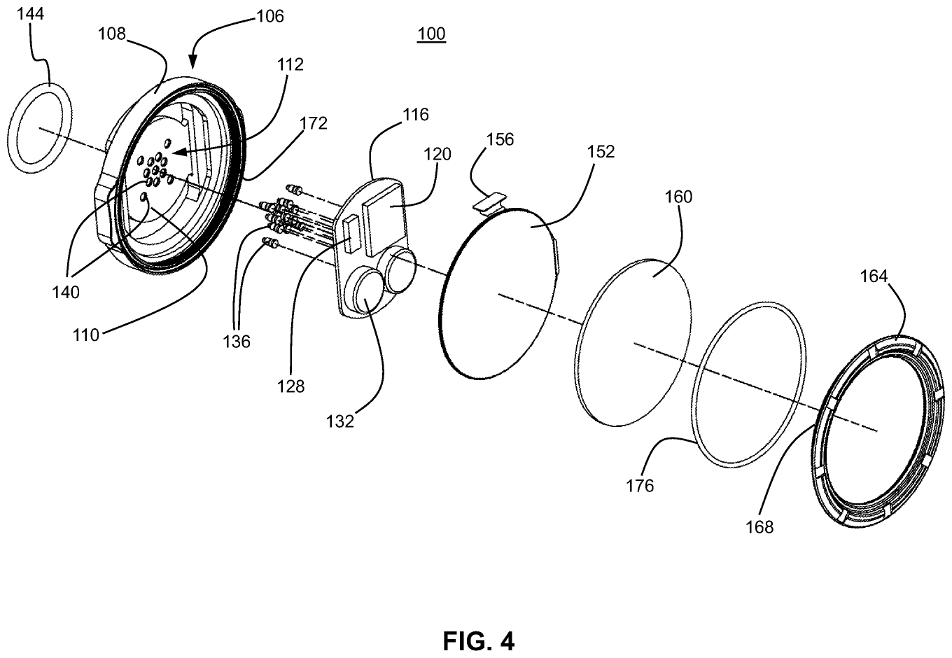

Referring now to FIG. 4, there is shown an exploded view of the personal digital module 100. The personal digital module 100 includes a base 106 having peripheral wall 108 and a rear wall 110 which cooperate to define a cavity 112.

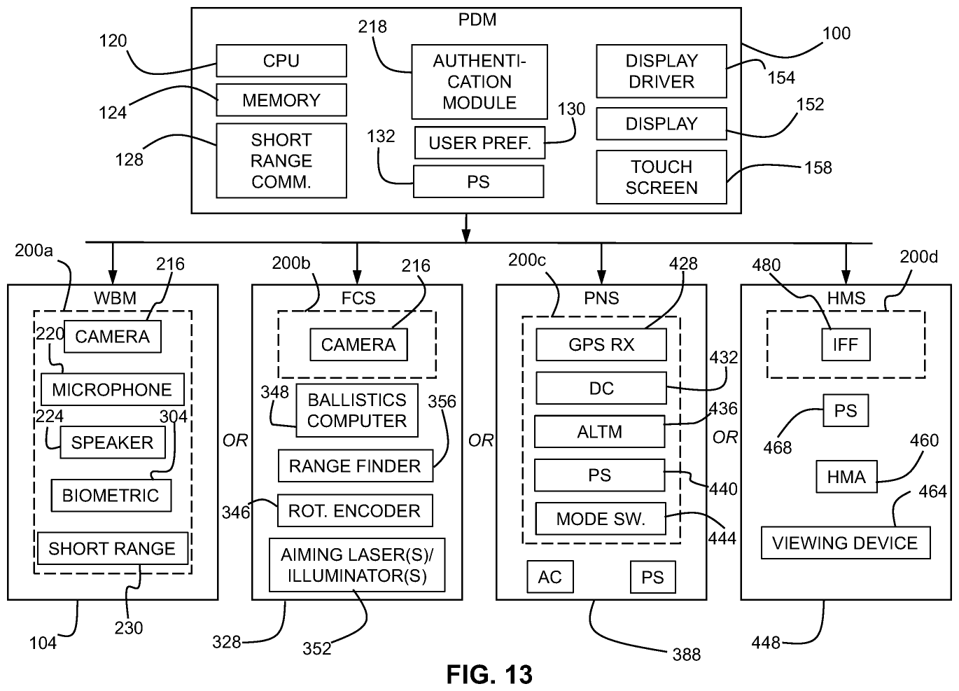

A main printed circuit board 116 is received within the cavity 112 and includes a processor 120 and an associated computer readable memory 124 (see FIG. 13) and a short-range radio frequency (RF) communications module 128.

The processor 120 is configured to execute computer programs, applications, methods, processes, or other software to perform embodiments described in the present disclosure. The processor may include one or more integrated circuit, microchip, microcontroller, microprocessor, central processing unit (CPU), graphics processing unit (GPU), digital signal processor (DSP), field programmable gate array (FPGA), or other circuits suitable for executing instructions or performing logic operations.

The memory 124 provides storage of instructions and data for programs executing on the processor 120. The memory 124 is typically semiconductor-based memory as would be generally understood by persons skilled in the art, such as read-only memory (ROM), programmable read-only memory (PROM), erasable programmable read-only memory (EPROM), electrically erasable programmable read-only memory (EEPROM), flash EEPROM or other flash memory, and so forth and is intended to encompass multiple memories, such as a main memory and an auxiliary memory, if desired.

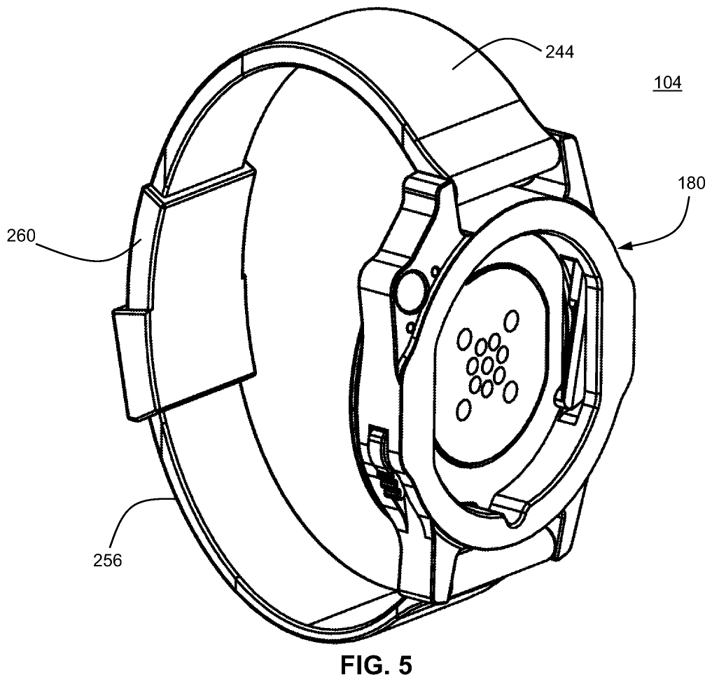

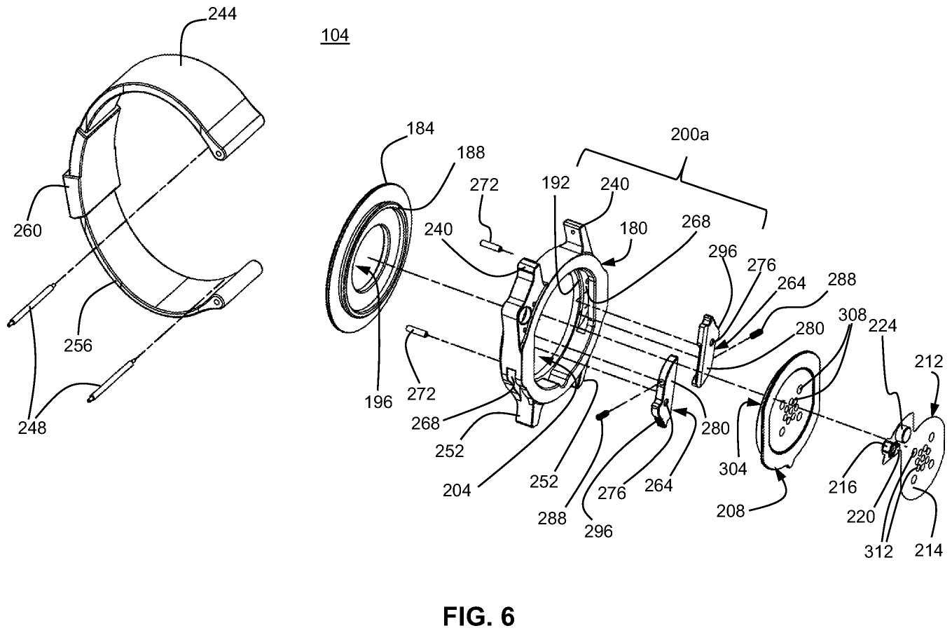

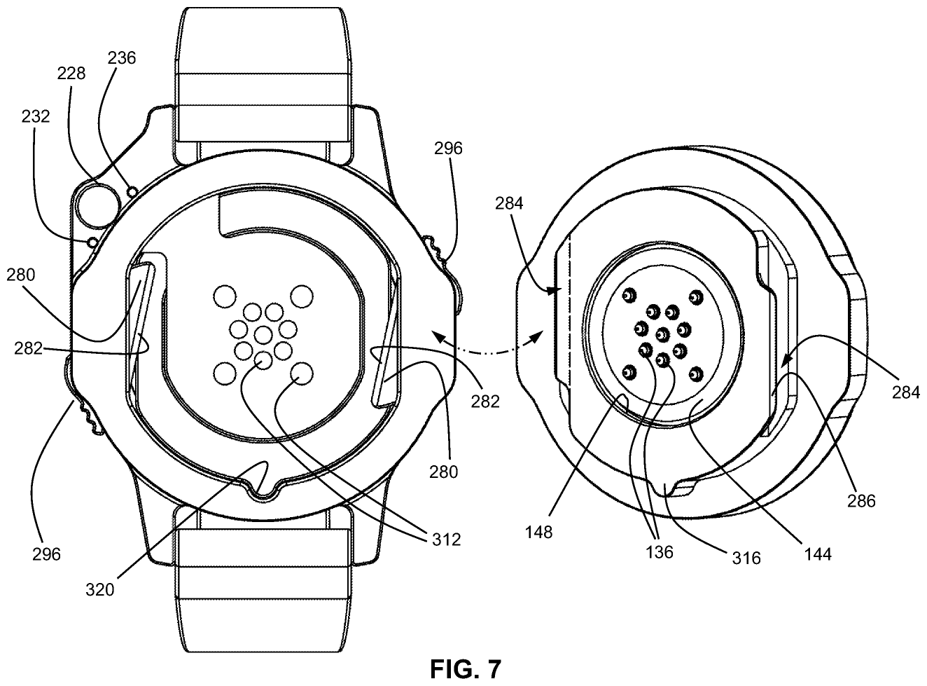

Referring now to FIGS. 5-13, and with continued reference to FIGS. 1-4, the processor 120 is programmed to implement a mode of operation based on input received from a device to which is it attached, for example, one of the devices 104, 328, 388, and 448 as described below. In addition, a user preferences module 130, which may be implemented as a module in the memory 124, is configured to automatically communicate under the control of the processor 120 with a device to which is it is attached to store user preferences concerning one operational settings of the attached device, wherein the attached device is configured to receive the user preferences from the personal digital module 100. The term “user preferences” means data specified by a user that is specific to a user or a customizable configuration representative of how a particular user chooses to configure the attachable devices while utilizing the apparatus as described herein.

The short-range RF communications module 128 receives and sends RF signals and includes circuitry configured to establish a short-range wireless link via one or more communications protocols, such as Bluetooth, Wi-Fi, Near Field Communication (NFC), or any other wireless pairing protocol usable for short-range communication.

One or more batteries 132 are disposed on the main board 116 and supply power to the components of the personal digital module 100. In embodiments, the one or more batteries include one or more rechargeable batteries.

A plurality of power and data contact pins 136 are operably electrically couples to the main board 116 and extend through openings 140 in the rear wall 110. In embodiments, the contact pins 136 are spring-loaded contact pins, e.g., pogo pins. An O-ring 144 is disposed within an annular groove or channel 148 surrounding the openings 140 and the pins 136 to protect the contacts 136 and openings from moisture/contamination.

A display 152 is disposed over the main board 116 in the base 106 and is operably coupled to the main board via a display connector 156. In embodiments, the display is a liquid crystal display (LCD), light-emitting diode (LED) display or organic light-emitting diode (OLED) display. Display driver circuitry 154 is configured to drive the display panel 152. In embodiments, the display 152 further includes a touch screen overlay 158 for providing user input to the processor 120. The display 152 is configured to display one of a plurality of user interfaces, wherein the user interface to be displayed is selected automatically according to the device to which is attached and/or the user preferences.

In embodiments, the display 152 has a brightness and/or contrast control, e.g., wherein the screen is dimmable to reduce eye splash when used in nighttime operations, wherein brightness and contrast can be increased for use in bright light conditions, and so forth. In embodiments, the screens brightness and/or contrast is manually adjustable, e.g., via a menu or other user interface feature on the display 152. In certain embodiments, a sensor 162, such as a photosensor, is provided to detect a level of ambient or background light and automatically adjust the brightness and/or contrast of the display 152 based on the ambient brightness level. In this manner an optimal brightness and/or contrast of the display 152 is ensured for various ambient lighting conditions.

A transparent display window 160 is disposed over the display 152. A bezel 164 engages the personal digital module base 106 via threads 168 which engage complementary threads 172 in the personal digital module base 106. A compression O-ring seal 176 is disposed intermediate the bezel 164 and the window 160 to provide a sealing interference against water, moisture, or other contamination entering the interior of the personal digital module 100.

Referring now to FIGS. 5-7, the watch base module 104 includes a body 180 having a threaded rear cover 184 attached thereto with external threads 188 which engage complementary internal threads 192. The rear cover 184 includes an opening 196 therethrough. The body 180 defines an interior compartment 204 and includes retentions and release features as will be described below to define a first common receiver socket or receptacle 200a for releasably attaching the personal digital module 100.

A biometrics sensor module 208 and an audio/visual (A/V) circuit board 212 are disposed within the interior 204. In embodiments, the A/V circuit board 212 comprises a flexible film substrate 214. A camera 216 is disposed on the A/V circuit board 212. In embodiments, the personal digital module 100 includes a biometrics or authentication module 218 stored in the memory 124 and executable by the processor 120 for transitioning the personal digital module 100 from a locked state to an unlocked state. In embodiments, the biometrics module 218 includes facial recognition software configured to analyze one or more images of the user acquired by the camera 216 and to perform facial recognition techniques to detect an authorized user(s) of the personal digital module 100 having digital representations such as image files, e.g., JPEG files, GIF files, etc., stored in the memory 124. It will be recognized that other biometric identification means may also be used, such as iris recognition, fingerprint recognition, or voice recognition techniques using pre-stored digital representations from an authorized user of the personal digital module 100. In embodiments, user identification may be performed using input from the biometrics sensor module 208.

A microphone 220 and an audio transducer 224 (e.g., speaker) are disposed on the A/V circuit board 212 to provide an audio interface for the personal digital module 100. The camera 216, microphone 220, and speaker 224 are aligned with openings or ports 228, 232, and 236, respectively, formed in the body 180.

The body 180 includes a pair of spaced apart upper struts 240 engaging a first band strap 244 via a spring bar pin 248 and a pair of spaced apart lower struts 252 engaging a second band strap 256 via a spring bar pin 248. A buckle or clasp 260 is provided to releasably secure the free ends of the first and second band straps 244, 256.

Lock bars 264 are pivotally attached to the body 180 via pivot pins 272 passing through openings 274 in the body 180 and openings 276 in the lock bars 264. The lock bars 264 are pivotally received within lock bar receptacles 268. The lock bars 264 include a blade portion 280 which releasably engages a corresponding slot 284 on the personal digital module 100. Ramped or inclined edges 282 on the lock bar blade portions 280 cooperate with ramped or inclined edges 286 on the personal digital module connection interface portion to facilitate movement of the lock bars 264 into the slots 284.

Tension springs 288 are captured between the lock bars 264 and the body 180 and bear against the blade portions 280 to urge the blade portions 280 into the slots 284 when the personal digital module 100 is attached to the watch base module 104.

The lock bars 264 further include lever portions 296 which are manually accessible through the openings 268 to manually pivot the lock bars 264 against the urging of the springs 288 to retract the blade portions 280 into the slots 284 when it is desired to remove the personal digital module 100 from the watch base module body 104.

Physiological electrodes/sensors 304 on the biometric sensor module 208 extend through the opening 196 and engage the skin of the user when the user is wearing the watch base module 104 for measuring one or more physiological biomarkers of the user. In embodiments, the electrodes/sensors 304 include electrodermal activity/galvanic skin response (EDA/GSR) for measuring the EDA of the wearer. In embodiments, the electrodes/sensors 304 include electrocardiogram (ECG) sensors for sensing the cardiac rhythm/electrical activity of the wearer. In embodiments, the sensor output is sent to the processor 120 and compares to digital representations stored in the memory 124 to detect an authorized user(s) of the personal digital module 100 using recognition techniques. A short-range RF transceiver module 230 is in communication with the short-range RF communications module 128 to provide a wireless communications interface between the watch base module 104 and the personal digital module 100 when the personal digital module is removed from the watch base module interface socket 200a.

In embodiments, the personal digital module 100 is configured to monitor for the presence of biometric data from the user via the biometrics module 304. In embodiments, the biometric data can be monitored, e.g., at periodic intervals, for one or more biometric features associated with the user. In this manner, the personal digital module 100 may be configured to monitor for the presence of the user. In embodiments, the user is re-authenticated at periodic intervals. In embodiments, when the biometric data from the biometric module 304 correlates with the stored biometric data in the authentication module 218, the user is re-authenticated and the user is allowed continued access to the personal digital module 100. When biometric data from the biometric module 304 is either not received, e.g., because the personal digital module 100 is out of range of the short-range communications module 230 of the watch base module 104 or because user is no longer wearing the watch base module 104, or, if the biometric data received from the watch base module 104 does not correlate with the stored biometric data in the authentication module 218, access to the personal digital module 100 is denied, e.g., by locking the device.

Contact pads 308 on the biometric sensor module 208 are in electrical communication with contact pads 312 on the A/V module 212, which, in turn engage the pins 136 on the personal digital module 100 when the personal digital module 100 is attached to the watch base module 104. An alignment lug 316 engages a complementary alignment notch 320 to provide proper rotational orientation of the personal digital module 100 with respect to the watch base module 104.

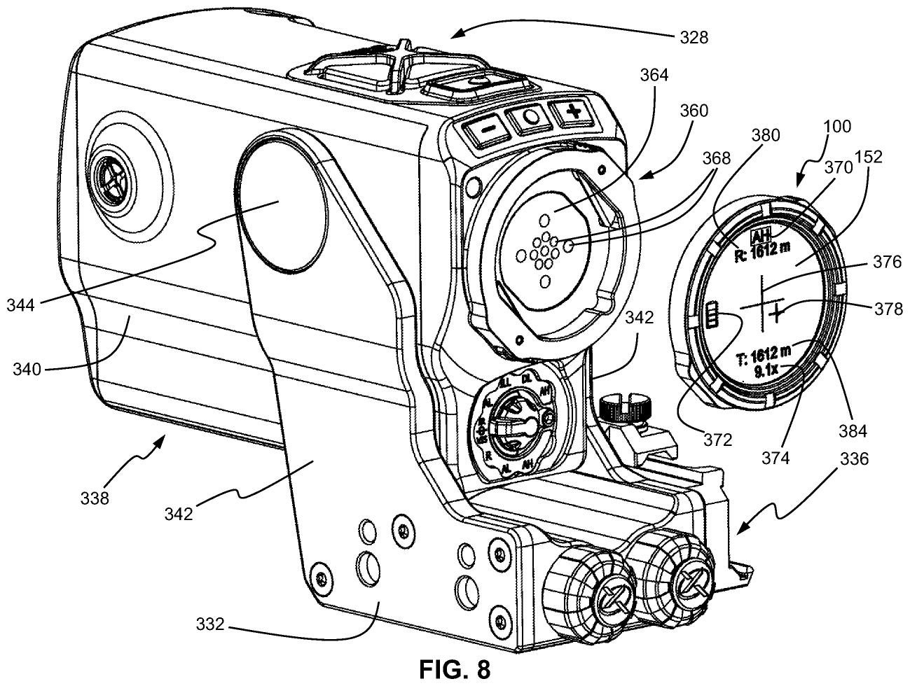

Referring now to FIG. 8, there is shown an exemplary fire control system 328 configured to receive the personal digital module 100, which provides a modular, removable human-viewable user interface for the fire control system 328 in lieu of an integral or built in fire control system display screen. The fire control system 100 includes a base 332 having a rail clamp assembly 336 for detachably attaching the fire control system 100 to an accessory mounting rail of a weapon, such as a rifle, grenade launcher, hand held rocket or missile delivery systems, and others.

The fire control system 328 further includes a main body 338 having a housing 340. The main body 338 is pivotally supported between upstanding struts or arms 342. The main body is pivotable about a pivot point 344. A rotary encoder 346 is provided to determine the relative angle between the main body 338 and the base 332.

The fire control system 328 includes a ballistics computer 348 and one or more aiming or pointing lasers 352. In embodiments, the fire control system 328 includes an optical range finder 356 for determining a distance to a selected target. In embodiments, the optical range finder may be omitted and the distance to a desired target may be determined through other means, such as an external range finder or other range determination or estimation method(s).

After the distance to the target is determined and input, either by an onboard range finder 356 or otherwise input by the user, the ballistics computer 348 performs a ballistics calculation to calculate the appropriate angle of trajectory of the weapon relative to a line of sight between the user and the target. In embodiments, the ballistics computation is made based on the trajectory data for the particular firearm or artillery and/or particular munition/projectile with which the fire control system 328 is being used. In embodiments, the trajectory data for a plurality of firearms or artilleries and/or munition/projectile types may be stored in a memory associated with the fire control system 328 and ballistics computer 348 and/or in the memory 124 of the personal digital module 100. In embodiments, ballistics computations are made based on the distance to the target and one or more environmental factors such as wind speed and direction, temperature, barometric pressure, among others.

In operation, once the trajectory is calculated, the main body 338 is rotated about the pivot axis 344 until the relative angle between the base 328 (and thus the bore of the barrel of the weapon) is such that aligning the laser 352 with the target will cause the weapon to be positioned at the proper angle for firing a projectile so that the path of the projectile will substantially intersect with the position of the target. In certain embodiments the main body 328 is configured to be manually rotated until the calculated trajectory distance corresponds to the distance determined by the range finder and/or other range determination method. Alternatively, the fire control system 328 further includes a motorized drive system (not shown) configured to rotate the main body 328 under programmed control to the calculated trajectory angle.

The fire control system 328 includes a personal digital module interface 360 which defines common receiver socket 200b for personal digital module 100. The interface 360 includes releasable mounting features which are as described above by way of reference to the common receiver socket 200a. The interface 360 includes a fire control system circuit board 364 having contact pads 368 which contact the electrical contact pins 136 on the personal digital module 100 to operably couple the personal digital module 100 to the parachutist navigation system 388.

In the illustrated embodiment, the display 152 is shown with an exemplary human viewable interface comprising, in certain embodiments, an indicium 370 which depicts a “laser on” warning to the user. In certain embodiments, an indicium 372 is displayed, which is representative of the battery level. In certain embodiments, an indicium 374 is displayed, which is representative of the camera optics zoom level. In certain embodiments, a main reticle indicium 376 is displayed, which represents an aim point that is bore sighted to the associated weapon. In certain embodiments, a disturbed reticle indicium 378 is displayed, representing a modified aim point that is calculated based upon the weapon, munition, environment, etc.

In certain embodiments, the distance to the target, i.e., as determined using the rangefinder 356 or via other apparatus or method, is output to the display 152 as range to target indicium 380. The distance to target for which the fire control system 328 is currently set based on the rotational angle of the main body 338 in relation to the base 332 is displayed as an indicium 384. The target setting distance displayed as the indicium 384 scrolls though the target setting distance based on the angular information from the encoder 346 as the main body 338 is rotated. In operation, the user rotates the main body 338 until the value displayed for the range indicium 384 matches or substantially matches the distance as determined by the range finder 356 or other apparatus or method and displayed as indicium 384. It will be recognized that indicia representative of other information, as well as other configurations of display indicia on the display 152, are also contemplated.

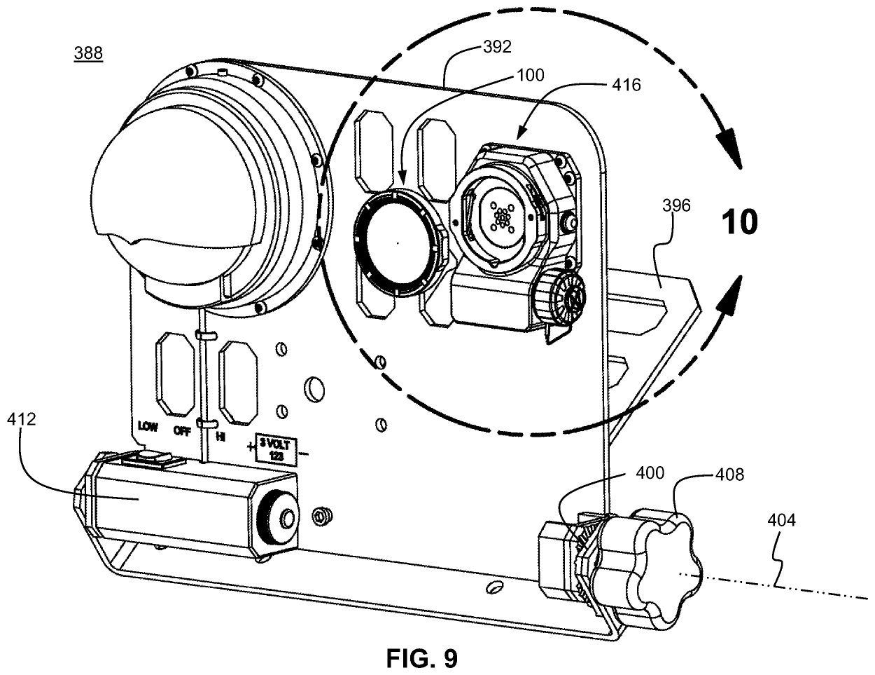

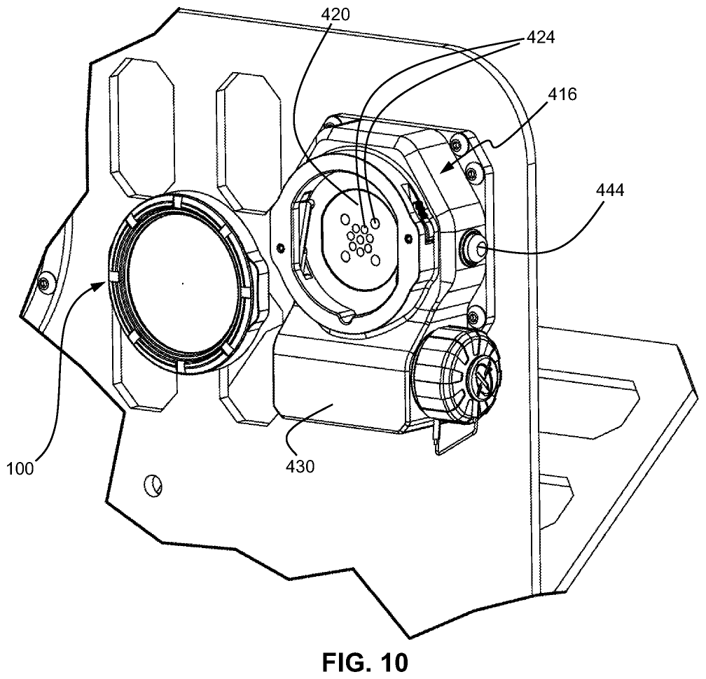

Referring now to FIGS. 9 and 10, there is shown an exemplary parachutist navigation system 388 which is configured to receive the personal digital module 100, which provides a modular, removable human-viewable user interface for the parachutist navigation system 388 in lieu of a separate GPS unit or mobile device such as personal digital assistant, smart phone, or the like.

The parachutist navigation system 388 includes an instrument board 392 and a back plate 396 attached to the instrument board 392 via a hinge 400 defining a pivot axis 404. The back plate 396 is configured to attached to a garment or parachute harness worn by the user, e.g., on the chest or torso of the user. During operation, the instrument board 392 is pivoted to a viewable position, e.g., once the parachutist is under the parachute canopy. A knob 408 is tightenable by the user to secure the instrument board 392 in the viewable position. In embodiments, a power supply 412 is provided on the instrument board 392 to operate onboard components such as a heating element or backlight (not shown) for the instruments or instrument compartments. In embodiments, an analog compass 414, such as a liquid filled, ball-type compass, is also provided on the instrument board 392.

A personal digital module interface 416 is disposed on the instrument board 392 and defines a common socket/receiver 200c for the personal digital module 100. The interface 416 includes releasable mounting features which are as described above by way of reference to the common receiver socket 200a. The interface 416 includes a parachutist navigation system circuit board 420 having contact pads 424 which contact the electrical contact pins 136 on the personal digital module 100 to operably couple the personal digital module 100 to the parachutist navigation system 388.

The interface 416 includes a satellite-based positioning system receiver 428. The satellite-based positioning system receiver 428 is advantageously implemented using Global Positioning System (GPS), although other global or regional navigation satellite systems, such as Global Navigation Satellite System (GLONASS), are also contemplated. The interface unit 416 also includes an electronic or digital compass 432 for indicating a direction in which the unit 416 is pointing and an altimeter 436.

A battery compartment 430 contains a power supply 440 for powering the components of the interface unit 416 and a mode select switch 444 is provided for cycling the between global positioning mode, compass mode, and altimeter mode, wherein the human viewable output on the display 152 changes in accordance with the selected mode.

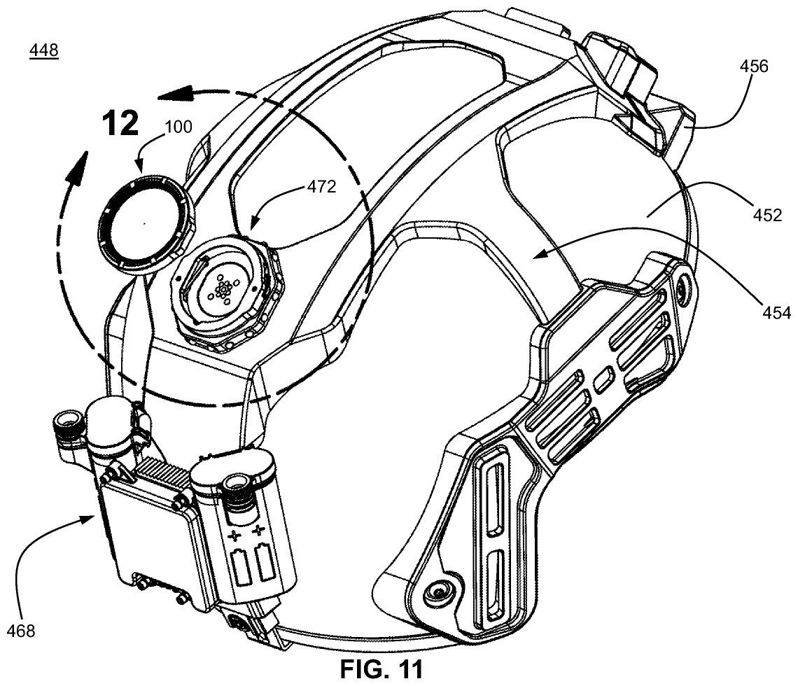

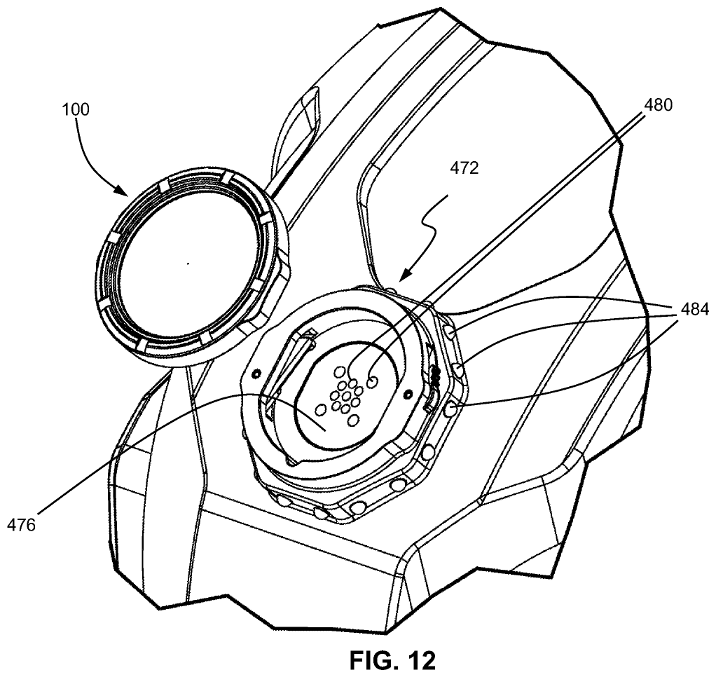

Referring now to FIGS. 11 and 12, there is shown an exemplary helmet mount system 448 which is configured to receive the personal digital module 100, which is configured to function as the CPU or controller for devices contained in or accessed by the helmet system 448.

The helmet mount system 448 includes a helmet 452 having an accessory interface assembly 454. In embodiments, the accessory interface assembly 454 is configured to provide mechanical connection of accessory devices to the helmet 452 as well as electrical and/or electronic connections for power, data, and/or control signals.

The helmet mount system 448 includes a front shroud 456 assembly configured to receive a helmet mount assembly 460. The helmet mount assembly 460, in turn, is detachably coupled to a viewing device 464. The viewing device may be a monocular or binocular camera or optical device, such as a night vision device, thermal camera, or the like.

The helmet mount system 448 further includes a remote power supply or battery box 468 mounted at the rear of the helmet mount system 448. The power supply 468 is configured to provide electrical power to one or more connected devices via the helmet mount system 448.

A personal digital module interface 472 is disposed on the helmet mount system 448 and defines a common socket/receiver 200d for the personal digital module 100. The interface 472 includes releasable mounting features which are as described above by way of reference to the common receiver socket 200a. The interface 472 includes an identification friend or for (IFF) circuit board 476 having contact pads 480 which contact the electrical contact pins 136 on the personal digital module 100 to operably couple the personal digital module 100 to the helmet mount system 448 and one or more attached devices.

The interface 472 further includes IFF module 480 comprising an array of emitters 484 for covertly identifying the wearer as friendly or “blue force” personnel. In embodiments, the IFF array comprises emitters of a plurality of wavelengths selectable via the touchscreen input device 158. In embodiments, the IFF module 480 operated as a flashing or strobe beacon. Exemplary frequency spectra of the emitters 484 include thermal, near infrared (NIR), short wave infrared (SWIR), and/or white emitters. In embodiments, the emitters 484 comprise light emitting diodes (LEDs). In embodiments, the emitters 484 comprise laser diodes. When operated in thermal or SWIR modes, it emits no visible signature and is undetectable by conventional night vision equipment.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A personal digital module, comprising:
a housing;
a processor and an associated computer-readable memory disposed within the housing, the memory operably coupled to the processor and encoded with executable instructions;
a human-viewable display operably coupled to the processor and disposed within the housing;
a connection interface disposed on the housing and configured for detachable and interchangeable attachment of a first device and a second device;
wherein the processor is configured, upon execution of the executable instructions, to perform a first function associated with the first device when the personal digital module is attached to the first device and to perform a second function associated with the second device when the personal digital module is attached to the second device.

2. The personal digital module of claim 1, wherein the processor is configured, upon execution of the executable instructions, to receive a first set of user preferences from the first device when the personal digital module is attached to the first device and to receive a second set of user preferences from the second device when the personal digital module is attached to the second device.

3. The personal digital module of claim 1, wherein the human-viewable display further comprises a touch screen.

4. The personal digital module of claim 1, wherein the first device is a watch base module wearable on a wrist of a user.

5. The personal digital module of claim 4, further comprising:
said watch base module comprising one or more biometric sensors for collecting biometric data from the user; and
said executable instructions comprising an authentication module configured to biometrically authenticate the user.

6. The personal digital module of claim 5, further comprising a wireless communications interface between the personal digital module and the watch base module configured to transmit data from the one or more biometric sensors to the personal digital module.

7. The personal digital module of claim 6, wherein the personal digital module is configured to monitor for presence of the user at periodic intervals during operation of the first or second device.

8. The personal digital module of claim 6, wherein the personal digital module is configured to biometrically authenticate the user at periodic intervals during operation of the first or second device.

9. The personal digital module of claim 5, wherein the one or more biometric sensors are selected from the group consisting of a camera, an ECG sensor, and an EDA sensor.

10. The personal digital module of claim 4, wherein the watch base module includes an annular receptacle configured to detachably receive the connection interface, the annular receptacle having one or more pivoting lock bars engaging complementary slots on the connection interface.

11. The personal digital module of claim 10, wherein the one or more lock bars are manually actuatable for detaching the personal digital module from the watch base module.

12. The personal digital module of claim 1, wherein the second device is selected from the group consisting of a fire control system, a parachutist navigation system, and a helmet mounting system.

13. The personal digital module of claim 1, wherein the second device is a fire control system and wherein the personal digital module is configured to display one or more indicia associated with the fire control system, the one or more indicia selected from the group consisting of: battery power indicia, range to target indicia, laser status indicia, reticle indicia, zoom magnification indicia, and any combination thereof.

14. The personal digital module of claim 1, wherein the second device is a parachutist navigation system comprising a digital compass, an altimeter, and a global satellite positioning receiver, and wherein the personal digital module is configured to selectively provide a graphical user interface representative of orientation based on data received from the digital compass, altitude based on data received from the altimeter, and location based on data received from the global satellite positioning receiver.

15. The personal digital module of claim 1, wherein the second device is a helmet mounting system.

16. The personal digital module of claim 15, wherein the personal digital module is operable to control a function of a helmet-mounted device attached to the helmet mounting system.

17. The personal digital module of claim 15, wherein the helmet mounting system includes an IFF beacon, and wherein the personal digital module is operable to control operation of the IFF beacon.
